(19) United States
(12) Patent Application Publication
(10) Pub. No.: US 2018/0368161 A1
(43) Pub. Date: Dec. 20, 2018

(54) Usage of Physical Uplink Control Channel for Quasi-Periodic Control Signals

(71) Applicant: Nokia Solutions and Networks Oy, Espoo (FI)

(72) Inventors: Esa Tapani TIIROLA, Kempele (FI); Timo Erkki LUNTTILA, Espoo (FI); Kari Juhani HOOLI, Oulu (FI)

(21) Appl. No.: 16/060,454

(22) PCT Filed: Nov. 30, 2016
(86) PCT No.: PCT/EP2016/079186

§ 371 Date: Jun. 8, 2018

(30) Foreign Application Priority Data
Dec. 10, 2015 (EP) PCT/EP2015/079271

(51) Int. Cl. H04W 72/12; H04L 5/00; H04W 74/08; H04W 72/04

(52) U.S. Cl. CPC H04W 72/1268; H04W 72/1284; H04W 72/1215; H04W 74/0833; H04W 72/0413; H04L 5/0053

(57) ABSTRACT

Various communication systems may benefit from appropriate scheduling and distribution of control systems. For example, wireless communication systems may benefit from usage of a physical uplink control channel for quasi-periodic control signals. A method can include configuring a quasi-periodic signal resource for a user equipment. The method can also include communicating with the user equipment in accordance with the configured quasi-periodic signal resource.

### BACKGROUND

### Field

Various communication systems may benefit from appropriate scheduling and distribution of control systems. For example, wireless communication systems may benefit from usage of a physical uplink control channel for quasi-periodic control signals.

### Description of the Related Art

Release 13 (Rel-13) of long term evolution (LTE) of licensed assisted access (LAA) provides licensed-assisted access to unlicensed spectrum while coexisting with other technologies and fulfilling the regulatory requirements. In Rel-13 LAA, unlicensed spectrum is utilized to improve LTE downlink (DL) throughput. One or more LAA DL secondary cells (SCells) may be configured to a user equipment (UE) as part of DL carrier aggregation (CA) configuration, while a primary cell (PCell) may need to be on licensed spectrum. Rel-13 LTE LAA may evolve to also support LAA UL transmissions on unlicensed spectrum in LTE Rel-14.

Standardized LTE LAA solution in Rel-13 based on CA framework assumes transmission of uplink control information (UCI) on PCell, namely in the licensed band. However, there may be an extension of LAA with dual connectivity operation, allowing for non-ideal backhaul between PCell in licensed spectrum and SCell(s) in unlicensed spectrum. Additionally, there may be extension to standalone LTE operation on unlicensed spectrum. LTE standalone operation on unlicensed spectrum means that evolved Node B (eNB)/UE air interface may rely solely on unlicensed spectrum without any carrier on licensed spectrum. Both dual connectivity and standalone operation modes may need transmission of UCI/PUCCH on unlicensed spectrum. It's also possible to define UCI/PUCCH functionality e.g. as part of Rel-14 LAA even without support for standalone or dual connectivity operation on licensed carrier, e.g. in order to facilitate PUCCH offloading to from Macro cell to one or more unlicensed cells.

In LTE operation on unlicensed carriers, depending on the regulatory rules, the UE may need to perform listen before talk (LBT) prior to any UL transmission. Some exceptions may exist though. For example, at least in some regions, transmission of ACK/NACK feedback may be possible without LBT when immediately following a DL transmission, similar to WiFi operation. Short control signaling (SCS) rules defined for Europe by ETSI allow for transmission of control signaling with a duty cycle of no more than 5% over 50 ms period without performing LBT:

Short control signaling transmissions can refer to transmissions used by adaptive equipment to send management and control frames, such as ACK/NACK signals, without sensing the channel for the presence of other signals. It is not required for adaptive equipment to implement short control signaling transmissions.

If implemented, short control signaling transmissions of adaptive equipment may have, for example, a maximum duty cycle of 5% within an observation period of 50 ms.

At least in some regions, scheduled UL transmissions may in general be allowed without LBT, when the transmission follows directly a DL transmission before which the eNodeB has performed LBT and total transmission time covering both DL and UL is limited by the maximum Tx burst time defined by the regulator.

To ensure reliable operation with LBT, transmissions may be required to occupy effectively the whole nominal channel bandwidth (BW). This means that UL transmissions such as PUCCH and physical uplink scheduling channel (PUSCH) may be required to occupy a large BW. This can be achieved using interleaved frequency division multiple access (IFDMA), block-IFDMA as described in 3GPP R1-152815, or contiguous resource allocation. Each allocation with legacy subframe duration of 1 ms may include a large number of resource elements. Accordingly, a shorter duration of PUCCH (“Short PUCCH”) may offered, with application of time division multiplexing (TDM) between different channels such as PUCCH and PUSCH. Additionally, use of TDM in UL can be seen as feasible since typically the target scenario involves small cell, meaning that UE does not become power limited even with wider bandwidth allocations. Furthermore, TD allows to minimize the short PUCCH duration and thereby maximize the room for DL and UL shared channels.

On the other hand, dynamically triggered “Long PUCCH” may be used support extreme cell edge conditions and very large UCI payload.

In short, two basic PUCCH structures/containers are seen: short PUCCH, which can refer to a PUCCH structure occupying few symbols, such as 4 symbols, and which can be TDMed with PUSCH; and long PUCCH, which can refer to a PUCCH structure occupying a PUSCH B-IFDMA interlace and predefined transmission timing, such as 1 ms, and which can be FDMed with PUSCH (In principle it is possible to FDM also short PUCCH with PUSCH.) Short PUCCH may support multiple Short PUCCH formats. For example, there may be a Short PUCCH format designed for transmission of multiple HARQ-ACK bits, and another Short PUCCH format designed for transmission of PRACH, SR, SRS and bundled HARQ-ACK

Three different PUCCH transmission timing principles may be used in certain embodiments. Fast PUCCH is a transmission timing principle in which HARQ ACK/NACK transmission occurs on Short PUCCH following right after the corresponding DL Tx burst. Slow PUCCH is a transmission timing principle in which HARQ ACK/NACK transmission occurs “later on” on a PUCCH resource. Slow PUCCH transmission may be triggered by eNB. Periodic PUCCH is a transmission timing principle in which a periodic PUCCH resource is configured for the UE.

FIG. 1 illustrates a use of a combination of approaches. LBT may prevent fast PUCCH transmission on the following short PUCCH. Additionally, UE processing time limitation may prevent handling each subframe of transmission opportunity TxOP before fast PUCCH. Hence, multiple timing solutions may be used, including slow PUCCH.

Different options may be used for slow PUCCH transmission. These options include dynamic triggering of slow PUCCH transmission containing PDSCH HARQ-ACK. In this option, transmission on Short PUCCH resources can be triggered dynamically and HARQ-ACK can be conveyed as UCI on PUSCH (with or without PUSCH data). Another option is to use Periodic PUCCH resources. A third option is to use fast PUCCH resource on short PUCCH corresponding to the next DL Tx burst. Yet another option is to trigger short PUSCH dynamically.

FIG. 2 illustrates periodic PUCCH with and without listen before talk. Periodic PUCCH resources may be needed for physical random access channel (PRACH), sounding reference signal (SRS), and scheduling request (SR). Periodic PUCCH resources can be made available also for PDSCH HARQ-ACK transmission. Part of Short PUCCH resources may be reserved for Periodic PUCCH use (such RA preamble, SR and SRS). Periodic PUCCH resources may be configured to some of UEs. Periodic PUCCH can be seen as an alternative or a complementing solution for dynamically triggered Short PUCCH transmission.

As shown in FIG. 2, case 1 is periodic PUCCH operated without LBT. This case may follow, for example, short control signaling rules defined for Europe by ETSI. This case may involve deterministic usage of periodic PUCCH resources. For example, 4 single carrier frequency division multiple access (SC-FDMA) symbols/10 ms can correspond to an overhead of 2.9% (<5%).

Case 2 can be to apply one-shot LBT for Periodic PUCCH. In this case, PUCCH can be dropped in the case of negative LBT. This case may apply opportunistic usage of periodic PUCCH resources based on LBT. Relying on Periodic PUCCH resources only may limit the minimum periodicity especially for SR and RA preamble too much. For example when operating w/o LBT according to rules defined for short control signalling, the minimum periodicity is around 10 ms.

Periodic resources in LTE use absolute timing. For example, scheduling request transmission is configured in 3GPP TS 36.213 in the way described at section 10.1.5 “Scheduling Request (SR) procedure,” of that document, the entirety of which is hereby incorporated herein by reference.

The absolute timing approach used in LTE does not support scenarios such as transmission of periodical signals via fast/slow PUCCH resources or transmission of periodical signals via both periodic PUCCH resources and fast/slow PUCCH resources. In case of SR and PRACH, transmission of periodical signals can be understood as periodic transmission opportunities/resources for signals. In such cases, the UE may not necessarily transmit SR or PRACH periodically, but may require periodic resources for such transmissions.

### SUMMARY

According to certain embodiments, a method can include configuring a quasi-periodic signal resource for a user equipment. The method can also include communicating with the user equipment in accordance with the configured quasi-periodic signal resource.

In certain embodiments, a method can include determining that a valid physical uplink control channel is available. The method can also include determining that a relative time index of the physical uplink control channel corresponds to a configured user-equipment-specific quasi-periodic resource or relative time offset. The method can further include operating the user equipment based on the determined physical uplink control channel.

An apparatus, according to certain embodiments, can include at least one processor and at least one memory including computer program code. The at least one memory and the computer program code can be configured to, with the at least one processor, cause the apparatus at least to configure a quasi-periodic signal resource for a user equipment. The at least one memory and the computer program code can also be configured to, with the at least one processor, cause the apparatus at least to communicate with the user equipment in accordance with the configured quasi-periodic signal resource.

An apparatus, in certain embodiments, can include at least one processor and at least one memory including computer program code. The at least one memory and the computer program code can be configured to, with the at least one processor, cause the apparatus at least to determine that a valid physical uplink control channel is available. The at least one memory and the computer program code can also be configured to, with the at least one processor, cause the apparatus at least to determine that a relative time index of the physical uplink control channel corresponds to a configured user-equipment-specific quasi-periodic resource or relative time offset. The at least one memory and the computer program code can further be configured to, with the at least one processor, cause the apparatus at least to operate the user equipment based on the determined physical uplink control channel.

According to certain embodiments, an apparatus can include means for configuring a quasi-periodic signal resource for a user equipment. The apparatus can also include means for communicating with the user equipment in accordance with the configured quasi-periodic signal resource.

In certain embodiments, an apparatus can include means for determining that a valid physical uplink control channel is available. The apparatus can also include means for determining that a relative time index of the physical uplink control channel corresponds to a configured user-equipment-specific quasi-periodic resource or relative time offset. The apparatus can further include means for operating the user equipment based on the determined physical uplink control channel.

A computer program product can, according to certain embodiments, encode instructions for performing any of the above-described methods.

A non-transitory computer-readable medium can, in certain embodiments, encode instructions that, when executed in hardware, perform any of the above-described methods.

### BRIEF DESCRIPTION OF THE DRAWINGS

For proper understanding of the invention, reference should be made to the accompanying drawings, wherein:

FIG. 1 illustrates a use of a combination of approaches.

FIG. 2 illustrates periodic PUCCH with and without listen before talk.

FIG. 3 illustrates signaling according to certain embodiments.

FIG. 4 illustrates a method according to certain embodiments.

FIG. 5 illustrates another method according to certain embodiments.

FIG. 6 illustrates an additional method according to certain embodiments.

FIG. 7 illustrates a system according to certain embodiments.

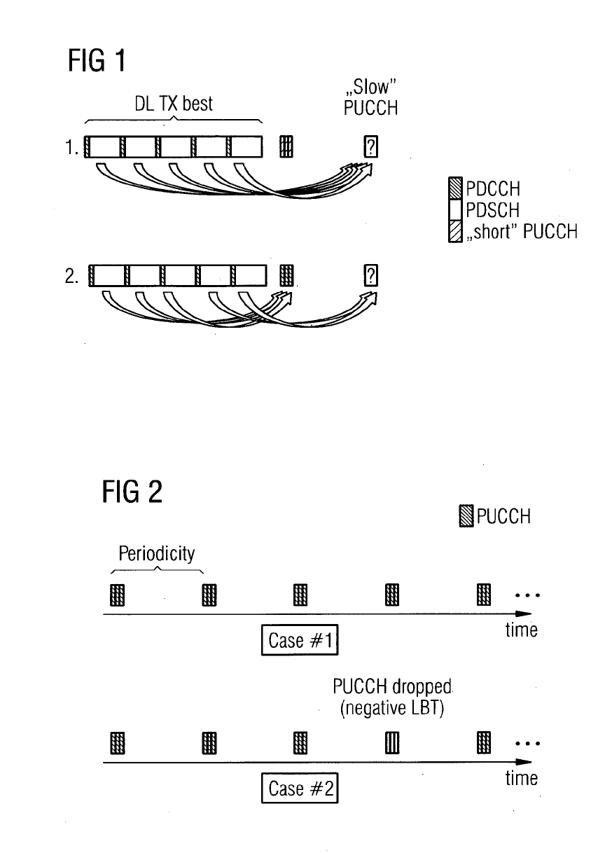

### DETAILED DESCRIPTION

Periodic resources may be needed, for example, for scheduling request (SR), physical random access channel (PRACH) and periodic channel state information (CSI). It is possible to use periodic physical uplink control channel (PUCCH) resources for periodic signals.

On the other hand, aperiodic PUCCH may play a significant role in license assisted access (LAA) standalone operation. For example, there may be usage of aperiodic PUCCH for hybrid automatic repeat request acknowledgment (HARQ-ACK). Furthermore, uplink (UL) bursts may not always occur periodically due to channel contention and LBT, as seen from Case#2, discussed above. Thus, there may be support for transmission of periodic signals also on aperiodic PUCCH resources.

Certain embodiments address the issue of how to efficiently use aperiodic PUCCH resources, such as fast/slow PUCCH, also for (quasi-) periodic signals, such as for SR/PRACH/P-CSI. More particularly, certain embodiments consider transmission of UL control information—in particular periodic transmission or transmission opportunities for UL control signals, such as scheduling request (SR), periodic CSI (P-CSI) and random access preamble on physical random access channel (PRACH).

Thus, certain embodiments may support transmission of quasi-periodic signals, namely signals that appear somewhat periodically, with limited variation in periodicity. Non-limiting examples of quasi-periodic signals can include SR/PRACH/P-CSI. These quasi-periodic signals may be supported via aperiodic resources such as fast/slow PUCCH. Again, in case of SR/PRACH, transmission of quasi-periodic signals can be understood to refer to the quasi-periodic resource for the signal. However, for better readability, the term “transmission of quasi-periodic signal” is used to broadly refer to both actual signals and opportunities. Certain embodiments are based on the idea of a floating time reference where at least some timing information is conveyed as part of dynamic scheduling, such as downlink control information (DCI).

In certain embodiments, more particularly, an access node, such as an eNB, can configure at least one quasi-periodic signal for a UE. The quasi-periodic signal may be, for example, a scheduling request. The configuration can have the following properties. The configured quasi-periodic signal can utilize a floating timing reference, wherein at least part of the timing information can be received as part of dynamic scheduling, such as DCI.

Quasi-periodic signals can utilize a predefined resource(s) within fast/slow PUCCH resources on top of a predetermined PUCCH structure. This configuration can be indicated to the UE, for example, via radio resource control (RRC) signaling. Configuration can be made in a cell specific manner or in UE specific manner. The configuration may include, for example, a frequency domain resource such as an index of the PUCCH Block-IFDMA interlace, and/or a code domain resource such as orthogonal cover code and/or sequence cyclic shift.

Quasi-Periodic signals may have a predefined cycle length, t, corresponding to a maximum periodicity. The value, t, can also define the number of bits needed in the signaling by ceil(log2(t)). The value of t may be fixed in a specification or alternatively may be configurable via higher layer signaling

Transmission opportunities for quasi-periodic signals may be characterized by a predetermined relative resource offset index (m) in addition to predefined periodicity (n). The values of m and n may be indicated to the UE via RRC signaling.

Another option for indicating transmission opportunities for quasi-periodic signals is to configure a predetermined relative time offset value, tₒ, for a UE. In such a case, quasi-periodic signal may be transmitted only when a floating timing reference corresponds to the predetermined relative time offset value. The relative time offset can be indicated to the UE, for example, via RRC signaling

Prior to an occurrence of an aperiodic PUCCH resource, the eNB or other access node can signal at least an aperiodic time identity (ATI) associated with the aperiodic PUCCH. The ATI can act as a floating timing reference. The ATI can indicate the relative resource index within the predefined cycle length. Signaling of the ATI can be done using, for example, common DCI, UE-specific DCI, or some other common signal.

In certain embodiments, the UE will be able to use aperiodic PUCCH resources for quasi-periodic signals without dedicated grant triggering the signal/resource only if the following occur: the UE determines that a valid PUCCH is available; the UE determines that the PUCCH relative time index indicated by the aperiodic time identity ATI corresponds to the configured UE-specific quasi-periodic resource (m, n) or relative time offset (tₒ); and LBT is positive. Otherwise, the UE may wait for a next opportunity.

In an embodiment, periodic PUCCH resources that are in predefined places in time can increment an aperiodic PUCCH counter. In other words, such places can also be allowed transmission (Tx) opportunities for quasi-periodic resources. In another embodiment, periodic PUCCH resources are used similarly as current periodic PUCCH resources and aperiodic PUCCH resources (incl. counter) are considered as separate (complementary) resource pool for conveying periodic signals.

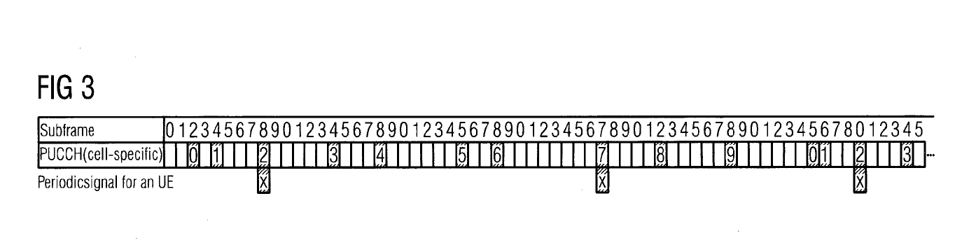

FIG. 3 illustrates signaling according to certain embodiments. As shown in FIG. 3, aperiodic PUCCH can have a predefined cycle length (t=10) in terms of number of instances, and can be indexed using ATI, ATI ε[0, 1, 2, . . . 9]. The shaded subframes with a number can illustrate a subframe containing (cell-specific) PUCCH.

The PUCCH may be fast PUCCH, slow PUCCH or periodic PUCCH. Usage of aperiodic PUCCH may also be limited to fast PUCCH or fast+slow PUCCH. The considered UE can have the following configuration for a quasi-periodic signal such as SR: relative resource offset index m=2 and periodicity n=5

The shaded subframes with an x illustrate subframes with UE-specific resource for SR according to a current configuration. Alternatively, a UE may be configured with a relative time offset (tₒ) containing those aperiodic PUCCH index values for which a UE has a valid UE-specific resource for the quasi-periodic signal. In the current example tₒεm[2,7]

Signaling options can include the following. For example, ATI can indicate the relative resource index within a predefined cycle length. Thus, when t=10, ATI may get values [0000, 0001, . . . , 1001]. Similarly, when t=16, ATI may get values [0000, 0001, . . . , 1111]. ATI can be included in DCI scheduling PDSCH and/or DCI scheduling PUSCH. ATI can be included in a common DCI transmitted PDCCH or EPDCCH. The use of a common DCI may be suitable for all periodic signals, such as SR and PRACH.

Signaling may include also subframe index for fast/slow PUCCH. This may be indicated in absolute manner, or in relativistic manner with respect to a known reference, such as a subframe conveying the ATI. The subframe index may also be derived from the signaling indicating the last/first subframe of DL or UL TxOP. By determining the subframe index for fast/slow PUCCH, UE can also determine that a valid PUCCH is available.

PUCCH may apply a predetermined channelization. The channelization may be different in short PUCCH and long PUSCH. The periodic signal may apply a predetermined resource index. The resource index may be mapped to a predefined CDM/FDM resource, for example using one or more of the following: B-IFDMA comb, cluster size; orthogonal cover code index; base sequence, cyclic shift; or demodulation reference signal (DM RS) resources.

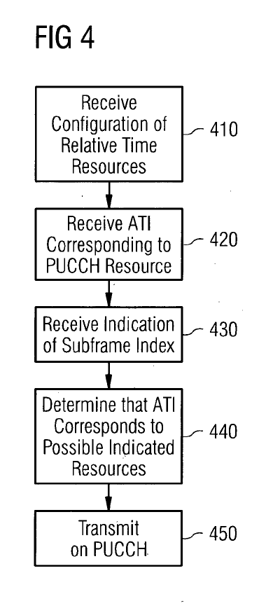

FIG. 4 illustrates a method for determining quasi-periodic transmission time resources for an uplink signal, according to certain embodiments. As shown in FIG. 4, the method can include, at 410, receiving from an access node such as an eNB configuration of relative time resources for transmission. The configuration can be provided via RRC configuration. The configuration can define the possible transmission time resources, for example in terms periodicity and relative resource offset, or in terms of a relative time offset. The configuration can include other necessary CDM and/or FDM parameters for determining a signal resource.

The method can also include, at 420, receiving from the eNB an aperiodic time identity (ATI) corresponding to the upcoming PUCCH resource. The ATI can be received, for example, via a common PDCCH.

The method can further include, at 430, receiving from an eNB also indication of the subframe index for the upcoming PUCCH. This may be explicitly indicated in the DCI, or derived from the subframe index carrying the DCI, together with the predetermined timing rules. For example, fast PUCCH may start after a predetermined time gap w.r.t. end of DL Tx burst.

If it is determined at 440 that the received ATI corresponds to one of the possible indicated transmission time resources, the method can also include at 450 transmitting a signal in the upcoming PUCCH on the determined signal resource. The signal may be a PRACH preamble, SR, or periodic CSI report (or any combination of those).

The signal can be transmitted based on whether other conditions are met. The other conditions may include positive LBT outcome, as well as events triggering random access attempt or scheduling request.

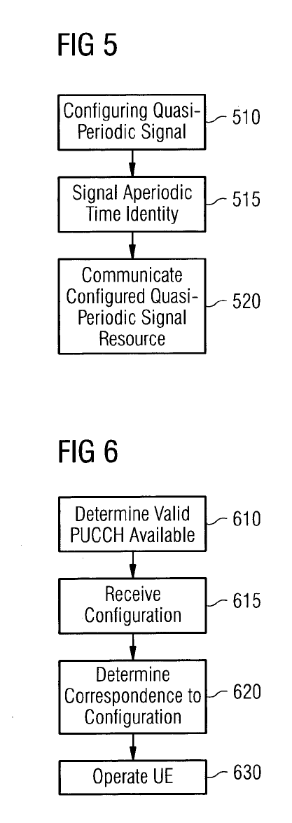

FIG. 5 illustrates another method according to certain embodiments. As shown in FIG. 5, a method can include, at 510, configuring a quasi-periodic signal resource for a user equipment. The method can also include, at 520, communicating with the user equipment in accordance with the configured quasi-periodic signal resource. The configured quasi-periodic signal resource can use a floating timing reference. The floating timing reference can be received as part of dynamic scheduling.

The configured quasi-periodic signal can use at least one predefined resource within fast/slow physical uplink control channel resources on top of a predetermined physical uplink control channel structure.

Transmission opportunities for the quasi-periodic signal can be characterized by a predetermined relative resource offset index in addition to a predefined periodicity. Alternatively, the transmission opportunities for the quasi-periodic signal can be characterized by a predetermined relative time offset value.

The method can further include, at 515, signaling an aperiodic time identity associated with an aperiodic physical uplink control channel resource, prior to occurrence of the aperiodic physical uplink control channel resource. The occurrence of the aperiodic physical uplink control channel resource can correspond to the communicating at 520, mentioned above.

FIG. 6 illustrates an additional method according to certain embodiments. As shown in FIG. 6, a method can include, at 610, determining that a valid physical uplink control channel is available. The method can also include, at 620, determining that a relative time index of the physical uplink control channel corresponds to a configured user-equipment-specific quasi-periodic resource or relative time offset. The method can further include, at 630, operating the user equipment based on the determined physical uplink control channel. For example, the operating here can refer to transmitting on the physical uplink control channel, as described above in connection with FIG. 4.

As shown in FIG. 6, the method can additionally, include, at 615, receiving configuration of a quasi-periodic signal for the physical uplink control channel from an access node. The determining the correspondence at 620 can be based on the received configuration of the quasi-periodic signal.

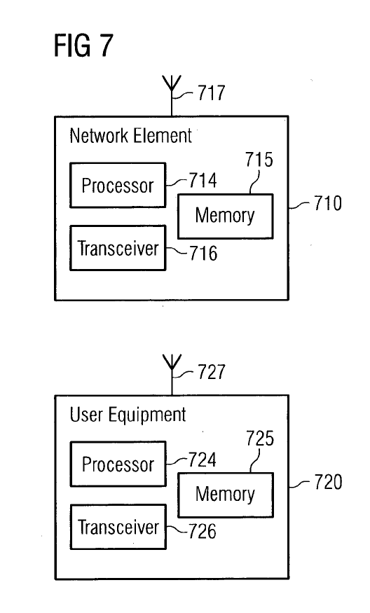

FIG. 7 illustrates a system according to certain embodiments of the invention. It should be understood that each block of the flowchart of FIGS. 4 through 6 may be implemented by various means or their combinations, such as hardware, software, firmware, one or more processors and/or circuitry. In one embodiment, a system may include several devices, such as, for example, network element 710 and user equipment (UE) or user device 720. The system may include more than one UE 720 and more than one network element 710, although only one of each is shown for the purposes of illustration. A network element can be an access point, a base station, an eNode B (eNB), or any other network element.

Each of these devices may include at least one processor or control unit or module, respectively indicated as 714 and 724. At least one memory may be provided in each device, and indicated as 715 and 725, respectively. The memory may include computer program instructions or computer code contained therein, for example for carrying out the embodiments described above. One or more transceiver 716 and 726 may be provided, and each device may also include an antenna, respectively illustrated as 717 and 727. Although only one antenna each is shown, many antennas and multiple antenna elements may be provided to each of the devices. Other configurations of these devices, for example, may be provided. For example, network element 710 and UE 720 may be additionally configured for wired communication, in addition to wireless communication, and in such a case antennas 717 and 727 may illustrate any form of communication hardware, without being limited to merely an antenna.

Transceivers 716 and 726 may each, independently, be a transmitter, a receiver, or both a transmitter and a receiver, or a unit or device that may be configured both for transmission and reception. The transmitter and/or receiver (as far as radio parts are concerned) may also be implemented as a remote radio head which is not located in the device itself, but in a mast, for example. It should also be appreciated that according to the “liquid” or flexible radio concept, the operations and functionalities may be performed in different entities, such as nodes, hosts or servers, in a flexible manner. In other words, division of labor may vary case by case. One possible use is to make a network element to deliver local content. One or more functionalities may also be implemented as a virtual application that is provided as software that can run on a server.

A user device or user equipment 720 may be a mobile station (MS) such as a mobile phone or smart phone or multimedia device, a computer, such as a tablet, provided with wireless communication capabilities, personal data or digital assistant (PDA) provided with wireless communication capabilities, portable media player, digital camera, pocket video camera, navigation unit provided with wireless communication capabilities or any combinations thereof. The user device or user equipment 720 may be a sensor or smart meter, or other device that may usually be configured for a single location.

In an exemplifying embodiment, an apparatus, such as a node or user device, may include means for carrying out embodiments described above in relation to FIGS. 4 through 6.

Processors 714 and 724 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors. Additionally, the processors may be implemented as a pool of processors in a local configuration, in a cloud configuration, or in a combination thereof.

For firmware or software, the implementation may include modules or unit of at least one chip set (e.g., procedures, functions, and so on). Memories 715 and 725 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity is typically internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as network element 710 and/or UE 720, to perform any of the processes described above (see, for example, FIGS. 4 through 6). Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, etc., or a low-level programming language, such as a machine language, or assembler. Alternatively, certain embodiments of the invention may be performed entirely in hardware.

Furthermore, although FIG. 7 illustrates a system including a network element 710 and a UE 720, embodiments of the invention may be applicable to other configurations, and configurations involving additional elements, as illustrated and discussed herein. For example, multiple user equipment devices and multiple network elements may be present, or other nodes providing similar functionality, such as nodes that combine the functionality of a user equipment and an access point, such as a relay node.

Certain embodiments may have various benefits and/or advantages. For example, certain embodiments may improve the efficiency of fast/slow PUCCH. Moreover, certain embodiments may reduce the need for periodical PUCCH resources. Additionally, certain embodiments may improve link and system performance due to improved CSI acquisition. Certain embodiments may further improve quality of experience (QoE), for example in terms of latency, when operating in unlicensed band.

Furthermore, certain embodiments may provide robustness to operation under LBT.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

### List of Abbreviations

3GPP Third Generation Partnership Project
ACK Acknowledgement
ATI Aperiodic Time Identity
B-IFDMA Block Interleaved Frequency Division Multiple Access
BW BandWidth
CA Carrier Aggregation
CCE Control Channel Element
CDM Code Division Multiplexing
CRC Cyclic Redundancy Check
CSI Channel State Information
DCI Downlink Control Information
DL Downlink
DM RS DeModulation Reference Signal
eNB Evolved NodeB
ETSI European Telecommunications Standards Institute
FDD Frequency Division Duplex
FDM Frequency Division Multiplex
HARQ Hybrid Automatic Repeat Request
IFDMA Interleaved Frequency Division Multiple Access
LAA Licensed Assisted Access
LBT Listen-Before-Talk
LTE Long Term Evolution
NACK Negative Acknowledgement
OFDMA Orthogonal Frequency Division Multiplexing
SC-FDMA Single-Carrier Frequency Division Multiplexing
PCell Primary cell
P-CSI Periodic Channel State Information
PDSCH Physical Downlink Shared Control Channel
PRACH Physical Random Access Channel
PUCCH Physical Uplink Control Channel
PUSCH Physical Uplink Shared Channel
RPF RePetition Factor
SCell Secondary cell (operating on un-licensed carrier in certain embodiments)
SCS Short Control Signaling
SR Scheduling Request
SRS Sounding Reference Signal
TB Transmission Block
TDD Time Division Duplex
TDM Time Division Multiplex
Tx Transmission
TXOP Transmission Opportunity
UCI Uplink Control Information
UE UserE Equipment
UL Uplink

1. A method, comprising:
configuring a quasi-periodic signal resource for a user equipment; and
communicating with the user equipment in accordance with the configured quasi-periodic signal resource.

2. The method of claim 1, wherein the configured quasi-periodic signal resource uses a floating timing reference.

3. The method of claim 2, wherein the floating timing reference is received as part of dynamic scheduling.

4. The method of claim 1, wherein the configured quasi-periodic signal uses at least one predefined resource within at least one of a physical uplink control channel immediately following a corresponding downlink transmission burst or physical uplink control channel triggered dynamically by an access node, on top of a predetermined physical uplink control channel structure.

5. The method of claim 1, wherein transmission opportunities for the quasi-periodic signal are characterized by a predetermined relative resource offset index in addition to a predefined periodicity.

6. The method of claim 1, wherein transmission opportunities for the quasi-periodic signal are characterized by at least one predetermined relative time offset value.

7. The method of claim 1, further comprising:
signaling an aperiodic or dynamic time identity associated with a dynamic physical uplink control channel resource, prior to occurrence of the aperiodic physical uplink control channel resource.

8. A method, comprising:
determining that a valid physical uplink control channel is available;
determining that a relative time index of the physical uplink control channel corresponds to a configured user-equipment-specific quasi-periodic resource or relative time offset; and
operating the user equipment based on the determined physical uplink control channel.

9. The method of claim 8, further comprising:
receiving configuration of a quasi-periodic signal for the physical uplink control channel from an access node, wherein the determining that the relative time index of the physical uplink control channel corresponds to the configured user-equipment-specific quasi-periodic resource or the relative time offset is based on the received configuration of the quasi-periodic signal.

10. An apparatus, comprising:
at least one processor; and
at least one memory including computer program code,
wherein the at least one memory and the computer program code are configured to, with the at least one processor, cause the apparatus at least;
configure a quasi-periodic signal resource for a user equipment; and
communicate with the user equipment in accordance with the configured quasi-periodic signal resource.

11-12. (canceled)

13. A non-transitory computer-readable medium encoded with instructions that, when executed in hardware, cause an apparatus at least to perform the process according to claim 1.

14. The method of claim 1, wherein the communicating comprises using the quasi-periodic signal resource for at least one of a random access preamble, a scheduling request, a sounding reference signal, or a periodic channel state information.

15. The method of claim 3, wherein the floating time reference is included in a common downlink control information indicating at least one property of a corresponding downlink transmission burst.

16. The method of claim 16, wherein the at least one property comprises end position.

17. The method of claim 7, wherein the aperiodic or dynamic time identity comprises information indicative of a relative time index.

18. An apparatus, comprising:
at least one processor; and
at least one memory including computer program code,
wherein the at least one memory and the computer program code are configured to, with the at least one processor, cause the apparatus at least to:
determine that a valid physical uplink control channel is available;
determine that a relative time index of the physical uplink control channel corresponds to a configured user-equipment-specific quasi-periodic resource or relative time offset; and
operate the user equipment based on the determined physical uplink control channel.

19. A non-transitory computer-readable medium encoded with instructions that, when executed in hardware, cause an apparatus at least to perform the process according to claim 8.

20. The apparatus of claim 10, wherein the configured quasi-periodic signal resource uses a floating timing reference.

21. The apparatus of claim 10, wherein the configured quasi-periodic signal uses at least one predefined resource within at least one of a physical uplink control channel immediately following a corresponding downlink transmission burst or physical uplink control channel triggered dynamically by an access node, on top of a predetermined physical uplink control channel structure.

22. The apparatus of claim 18, wherein the at least one memory and the computer program code are configured to, with the at least one processor, cause the apparatus at least to:
receiving configuration of a quasi-periodic signal for the physical uplink control channel from an access node, wherein the determining that the relative time index of the physical uplink control channel corresponds to the configured user-equipment-specific quasi-periodic resource or the relative time offset is based on the received configuration of the quasi-periodic signal.
